(19) United States
(12) Patent Application Publication
(10) Pub. No.: US 2022/0399623 A1
(43) Pub. Date: Dec. 15, 2022

(54) SMART VEHICLE BATTERY CLIP

(71) Applicant: SHENZHEN CITY QICAIGUOHONG TECHNOLOGY Co., LTD., Shenzhen (CN)

(72) Inventors: Zhangxiu Hu, Shenzhen (CN); Mu-Jung Tung, Shenzhen (CN); Junfeng Ke, Shenzhen (CN)

(21) Appl. No.: 17/343,962

(22) Filed: Jun. 10, 2021

(51) Int. Cl. H01M 50/597; H01M 50/581; H01M 10/42; H01M 10/48

(52) U.S. Cl. CPC H01M 50/597; H01M 50/581; H01M 10/4264; H01M 10/488; H01M 2220/20; H01M 2200/105

(57) ABSTRACT

The present disclosure provides a smart vehicle battery clip, comprising: two battery clips, an isolated power output circuit, an isolated polarity detection circuit, a polarity discrimination circuit, a protection circuit, a micro control unit and a power supply line, the isolated power output circuit is coupled with the two battery clips, the isolated polarity detection circuit and the isolated power output circuit are spaced apart, and the isolated polarity detection circuit is coupled with the two battery clips; the polarity discrimination circuit and the isolated polarity detection circuit are oppositely arranged, and the polarity discrimination circuit is isolated from the isolated polarity detection circuit; the micro control unit is coupled with the isolated power output circuit, the polarity discrimination circuit, the EC5 public socket, and the protection circuit; the power supply line is spaced apart from the micro control unit.

### TECHNICAL FIELD

The present disclosure relates to the field of battery clip technology, and in particular to a smart vehicle battery clip.

### BACKGROUND

Battery clip belongs to auto parts. The battery clips produced by manufacturers are made of high-quality metal materials, which are not only durable, wear-resistant, but also conductive. When the car is in use, if the battery cannot be started normally because of the aging or damage of the battery, then the battery clip can directly connect the emergency power supply to the battery, and charge the battery with power to start the car. The battery clip is used as an electrode clip for charging the battery. As long as the emergency power supply is connected to the end of the clip, the two ends of the battery clip are correctly clamped on the positive and negative electrodes of the battery.

The inventor of the present application has discovered in long-term research and development that the existing battery clips have low insulation and are prone to leakage, electric shock, static electricity, etc., which endanger the personal safety of users, and the battery clips cannot automatically identify the positive and negative electrodes of the battery. Therefore, damage caused by reverse polarity also often occurs.

### SUMMARY OF THE DISCLOSURE

The present disclosure provides a smart vehicle battery clip, which can avoid damage caused by reversed polarity connection of the battery clip in the prior art. The insulation of the battery clip is low, and it is prone to electric leakage, electric shock, static electricity and other phenomena, which endangers the personal safety of the user.

To solve the above-mentioned problems, a technical scheme applying in the present disclosure is to provide a smart vehicle battery clip, wherein the smart vehicle battery clip comprises: two battery clips, an isolated power output circuit, an isolated polarity detection circuit, a polarity discrimination circuit, a protection circuit, a micro control unit and a power supply circuit, the isolated power output circuit couples two of the battery clips, the isolated polarity detection circuit and the isolated power output circuit are spaced apart, and the two battery clips are coupled; the polarity discrimination circuit and the isolated polarity detection circuit are relatively arranged, and the polarity discrimination circuit and the isolated polarity detection circuit are isolated; the micro control unit couples the isolated power output circuit, the polarity discrimination circuit, an EC5 male socket, and the protection circuit; the power supply circuit is spaced apart from the micro control unit.

The technical effects provided in some embodiments of the present disclosure may include the following: different from the prior art, the present disclosure provides a smart vehicle battery clip, comprising: two battery clips, an isolated power output circuit, an isolated polarity detection circuit, a polarity discrimination circuit, a protection circuit, a micro control unit, a human-machine interface module, and a power supply circuit, the isolated power output circuit couples two of the battery clips, the isolated polarity detection circuit and the isolated power output circuit are spaced apart, and the two battery clips are coupled; the polarity discrimination circuit and the isolated polarity detection circuit are relatively arranged, and the polarity discrimination circuit and the isolated polarity detection circuit are isolated; the micro control unit couples the isolated power output circuit, the polarity discrimination circuit, an EC5 male socket, and the protection circuit; the power supply circuit is spaced apart from the micro control unit. The technical scheme of the present disclosure can automatically distinguish the polarity, so that the personal safety of the user can be guaranteed.

### BRIEF DESCRIPTION OF THE DRAWINGS

FIG. 1 is a schematic structural view of a smart vehicle battery clip according to an embodiment of the present disclosure.

FIG. 2 is a partial schematic structural view of a smart vehicle battery clip according to another embodiment of the present disclosure.

FIG. 3 is a schematic structural view of a second supply circuit according to an embodiment of the present disclosure.

FIG. 4 is a schematic structural view of an isolation polarity detection circuit and a polarity discrimination circuit according to an embodiment of the present disclosure.

FIG. 5 is a partial schematic structural view of a human-machine interface module according to an embodiment of the present disclosure.

FIG. 6 is a schematic structural view of a functional key switch according to an embodiment of the present disclosure.

FIG. 7 is a schematic structural view of an overcurrent protection circuit according to an embodiment of the present disclosure.

FIG. 8 is a schematic structural view of a high and low voltage protection circuit according to an embodiment of the present disclosure.

FIG. 9 is a schematic structural view of a temperature protection circuit according to an embodiment of the present disclosure.

### DETAILED DESCRIPTION

The embodiments of the present disclosure will be described clearly and completely with reference to the corresponding drawings as below. Obviously, the described embodiments are only a portion of the embodiments of the present disclosure and do not represent all of them. Based on the embodiments in the present disclosure, all of the other embodiments obtained by one of ordinary skill in the art without creation are within the scope of protection of the present disclosure.

It is noted that the terms of “first”, “second”, etc., in the embodiments of the present disclosure are only for descriptive purposes and cannot be understood as indicating or implying their relative importance or implicitly indicating the number of indicated technical features. Thus, a feature defined as “first”, “second” may expressly or implicitly include at least one of the features. Additionally, the technical schemes of the embodiments can be combined with each other. However, it must be based on what can be achieved by one of ordinary skill in the art. When the combination of technical solutions is contradictory or cannot be achieved, it should be considered that such a combination of technical solutions does not exist, and does not fall within the scope of protection required by this application.

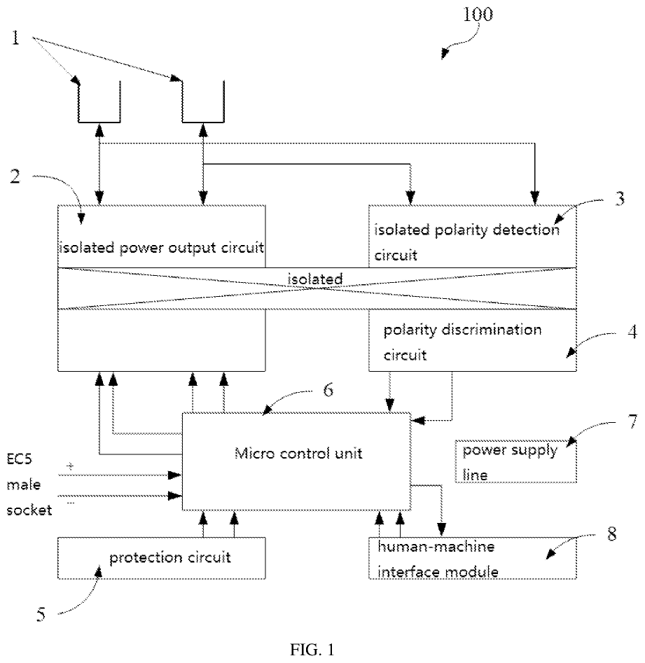

Referring to FIG. 1, FIG. 1 is a schematic structural view of a smart vehicle battery clip according to an embodiment of the present disclosure. The smart vehicle battery clip 100 disclosed in this embodiment includes two battery clips 1, an isolated power output circuit 2, an isolated polarity detection circuit 3, a polarity discrimination circuit 4, a protection circuit 5, a micro control unit 6, and a power supply line 7.

Specifically, the isolated power output circuit 2 is coupled with two battery clips 1. The isolated polarity detection circuit 3 is spaced apart from the isolated power output circuit 2, and coupled with the two battery clips 1. The polarity discrimination circuit 4 is arranged on the opposite side of the isolation polarity detection circuit 3, and the polarity discrimination circuit 4 is isolated from the isolation polarity detection circuit 3. The micro control unit 6 is coupled with an isolation power output circuit 2, a polarity discrimination circuit 4, an EC5 male socket, and a protection circuit 5. Power supply line 7 is coupled with the micro control unit.

The smart vehicle battery clip 100 proposed in the present disclosure is capable of automatically recognizing positive and negative polarity. The smart vehicle battery clip 100 is with an intelligent interface, and the product embodies the disclosure can realize the user blind-clipping, without worrying about how to clip correctly. During operation, there are no sparks and no other accidents will occur. Before being judged, it is the isolation of high insulation characteristics, and the electricity is sent only after being clamped, which prevents the instantaneous formation of electrical sparks. Unique isolation design, with high insulation characteristics at both ends, which can prevent electric leakage, electric shock, static electricity, etc., so as to improve the personal safety of users. Specially designed mutual restraint double protection circuit, there is no need to worry about external noise interference causing erroneous judgment and faults, so as to strengthen the safety and security of the people.

The present disclosure provides a smart vehicle battery clip 100, comprising: two battery clips 1, an isolated power output circuit 2, an isolated polarity detection circuit 3, a polarity discrimination circuit 4, a protection circuit 5, a micro control unit 6, and a power supply line 7, an isolated power output circuit 2 is coupled with two battery clips 1, an isolated polarity detection circuit 3 is spaced apart from the isolated power output circuit 2, and coupled with two battery clips 1. The polarity discrimination circuit 4 is arranged on the opposite side of the isolation polarity detection circuit 3, and the polarity discrimination circuit 4 is isolated from the isolation polarity detection circuit 3. The micro control unit 6 is coupled with an isolation power output circuit 2, a polarity discrimination circuit 4, an EC5 male socket, and a protection circuit 5. The power supply line 7 is spaced apart from the micro control unit. By setting the isolation power output circuit 2 and the isolation polarity detection circuit 3, which is the unique isolation design, with high insulation characteristics at both ends, it does not cause leakage, electric shock, static electricity, etc., and the isolated polarity detection circuit 3 can automatically determine the polarity, so that it can improve the personal safety of the user.

On the basis of the above embodiment, please refer to FIG. 2, which is a partial structural view of a smart vehicle battery clip according to another embodiment. The smart vehicle battery clip 100 disclosed in the present embodiment includes two battery clips 1, an isolated power output circuit 2, an isolated polarity detection circuit 3, a polarity discrimination circuit 4, a protection circuit 5, a micro control unit 6, and a power supply line 7. This embodiment of the smart vehicle battery clip 100 disclosed are the same as those described above, and will not be repeated here.

In an embodiment, the power supply circuit 7 may include a first supply circuit and a second supply circuit. The first supply circuit includes a diode D5, one end of the diode D5 is coupled with the IN+ end of a EC5 male socket, and the other end of the diode D5 is coupled with the VCC_12V end of the second supply circuit. The second supply circuit includes an R9 resistor, a capacitor C5, a DC regulator U13, and a capacitor C6, one end of the R9 resistor is coupled with a VCC_12V end, the other end is coupled with one end of the capacitor C5 and an IN pin of the DC regulator U13, the other end of the capacitor C5 is coupled with one end of the capacitor C6, one end of the capacitor C6 is coupled with an OUT pin of the DC regulator U13, and a VCC end. The two GND pins of the DC regulator U13 are coupled the other end of the capacitor C5 and a ground GND end.

In this embodiment, the power supply circuit product adopts a dual power line design, with one being +12 Vdc±10% and the other being +5 Vdc±5% 100 mA.

FIG. 2 is a schematic structural view of the first supply circuit, supplied by direct access to the power supply of the lithium battery: +12 Vdc voltage taken from the IN+ end of the EC5 receptacle, supplied to the product +12 Vdc power supply via a fast diode D5 with one-way drainage restriction, the label in the figure is VCC_12V.

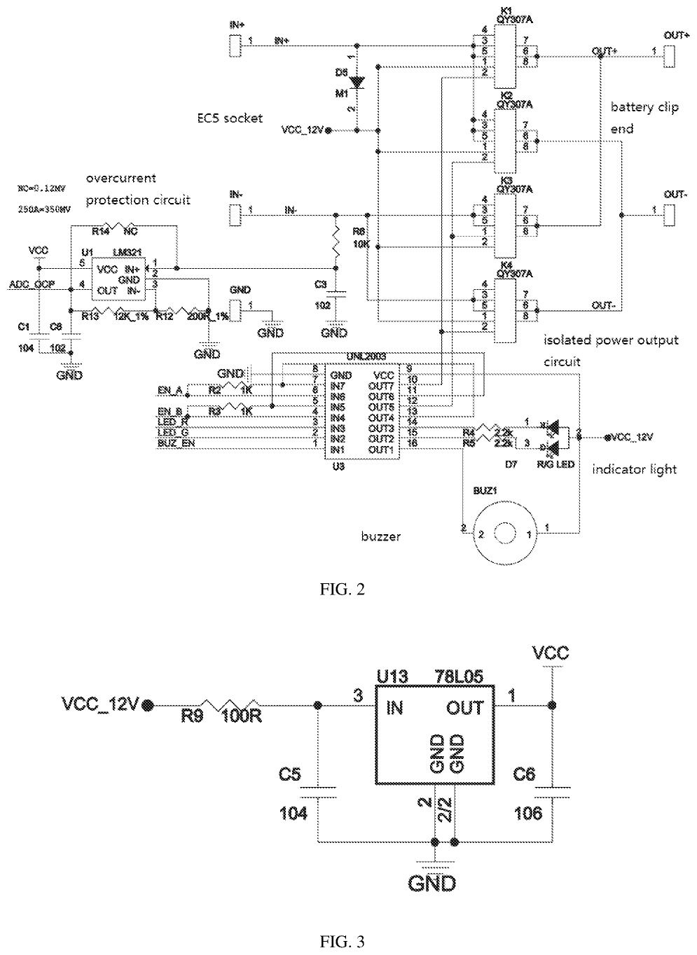

Referring to FIG. 3, FIG. 3 is a schematic structural view of a second supply circuit according to an embodiment. The power supply is provided by utilizing a step-down line: the +12 Vdc voltage is taken from the VCC_12V end, the resistor R9 is used for the lead current limit protection and the capacitor C5 MLCC is used for the filtering energy storage, which is directly led to the INPUT pin (3PIN) of the DC voltage regulator U13, the GND pin (2PIN) of the DC voltage regulator U13 is grounded, and the OUTPUT pin (1PIN) of the DC voltage regulator U13 is the voltage output pin, which is connected to a capacitor C6 MLCC for the filtering energy storage, and then the voltage power supply is provided to the product +5 Vdc. Electrical specifications of +5 Vdc±5% 100 mA are provided. The label in the figure is VCC.

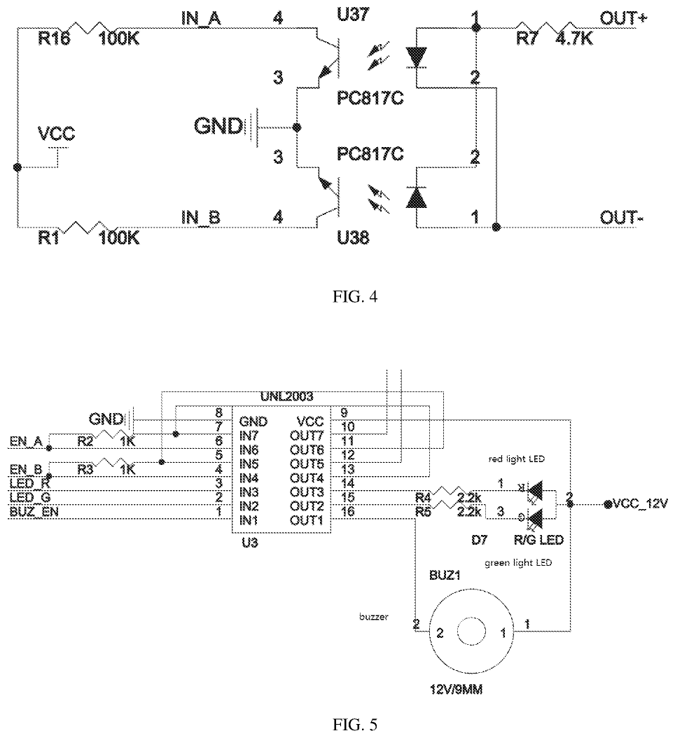

Please refer to FIG. 4, FIG. 4 is a structural view of an isolation polarity detection circuit and a polarity discrimination circuit according to an embodiment, wherein the left side is a polarity discrimination circuit and the right side is an isolation polarity detection circuit.

In this embodiment, the smart vehicle battery clip 100 includes a first optical coupling assembly U37 and a second optical coupling assembly U38, the first optical coupling assembly U37 includes a first light diode and a first light triode, and the second optical coupling assembly U38 includes a second light diode and a second light triode. The isolation polarity detection circuit 3 includes a resistor R7, both ends of the resistor R7 are coupled with a first end of the first light diode and an OUT+ end, respectively, a second end of the first light diode is coupled with a second end of the second light diode, and a first end of the second light diode is coupled with an OUT− end.

Isolation Polarity Detection Circuit 3 (on the side of clips)

Battery detection voltage range: 2.3 Vdc-20 Vdc

Detection judgment time: within 1.5 seconds, signal uninterrupted, judgment is deemed valid

Object used: optical coupling diode or isolation transformer.

Insulation impedance: 10¹⁴ Ω.

In an embodiment, the polarity discrimination circuit 4 includes a resistor R16 and a resistor R1, a collector pin of the first light triode is coupled with one end of the resistor R16, the other end of the resistor R16 is coupled with one end of the resistor R1 and a VCC end. The emitter foot of the first light triode is coupled with the emitter foot of the second light triode and the ground GND end, and the collector foot of the second light triode is coupled with the other end of the resistor R1.

Polarity Determination Circuit 4

Power range: +7 Vdc-+30 VDC.

Detection discrimination: receives the signal of the optical coupling diode and transmits it to the micro control unit 6. Detection judgment time: Within 1.5 seconds, signal uninterrupted judgment is deemed valid.

Object of use: optical coupling triode or isolation transformer

Insulation impedance: 10¹⁴ Ω.

Isolation Polarity Detection Circuit 3 adopts two groups of Photo Coupler first optical coupling assembly U37 and second optical coupling assembly U38, each group containing one optical diode and one optical triode.

On the isolation polarity detection circuit 3, there is a detection circuit constituted by the light diode assembly of a first optical coupling assembly U37 or a second optical coupling assembly U38. The detection circuit mainly performs the function of polarity recognition, transmitting a recognizable signal to the line of polarity discrimination. The 1PIN of the first optical coupling assembly U37 is coupled to the 2PIN of the second optical coupling assembly U38, and is coupled to the OUT+ end after connecting a resistor R7 for current limiting action. Once the 1PIN of the second optical coupling assembly U38 is coupled to the 2PIN of the first optical coupling assembly U37, the 1PIN of the second optical coupling assembly U38 is directly connected to the OUT− end. The principle of this connection way is designed with the unidirectional conductivity of the diode. The cathode and anode of the two diodes are connected upside down, and the polarity of the OUT end can be detected after passing a resistive current limiting. The principle is as following:

Case 1: The OUT+ end is the input positive voltage. The OUT− end is the input negative voltage. The positive electrode voltage at the OUT+ end flows along the resistor R7 to the PIN1 of the first optical coupling assembly U37 to couple with the anode of the light diode inside the first optical coupling assembly U37, at this time the diode is at the forward potential, and the positive electrode voltage leads along the anode to the PIN2 cathode of the first optical coupling assembly U37 and finally to the OUT− end. At this time, the light diode of the first optical coupling assembly U37 is in a conductive state and the optical signal is emitted. The positive electrode voltage at the OUT+ end flows along the resistor R7 to the PIN2 of the second optical coupling assembly U38 and connects to the cathode of the light diode inside the second optical coupling assembly U38, at this time, the diode is at the reverse potential, and the positive electrode voltage is cut off by the cathode. The circuit is interrupted at this time. At this time, the light diode of the second optical coupling assembly U38 is in the cut-off state and no light signal is emitted.

Case 2: The OUT+ end is the input negative voltage. The OUT− end is the input positive voltage. The positive electrode voltage at the OUT− end, flowing to the PIN 2 of the first optical coupling assembly U37, is connected to the cathode of the light diode inside the first optical coupling assembly U37, at this time, the diode is at the reverse potential, and the positive electrode voltage is cut off by the cathode. The loop is interrupted at this time. The positive voltage of the OUT− end flows to the PIN1 of the second optical coupling component U38 and is connected to the anode of the photodiode inside the second optical coupling component U38. At this time, the diode is at a forward potential, and the positive voltage flows along the anode to the first cathode of PIN2 of the second optical coupling component U38, finally leads to the OUT+ end through the R7 resistor. At this time, the photodiode of the second optical coupling component U38 is in a conducting state, and an optical signal is emitted. At this time, the photodiode of the first light coupling component U37 is in the cut-off state, and no light signal is emitted.

These two cases yield the logic table shown in Table 1, which is passed to the polarity discriminating circuit 4.

TABLE 1

| OUT + end | OUT − end | U37 optical signal | U38 optical signal |
|---|---|---|---|
| positive | negative | 1 | 0 |
| negative | positive | 0 | 1 |

In an embodiment, the isolated power output circuit 2 includes relays K1, K2, K3, K4, high voltage, high current composite transistor array U3, diode D5, and resistor R6, pin 3, 4, and 5 of relay K1 coupling the first end of diode D5, IN+ end, pin 4, and 3 of relay K2. Pin 1 of relay K1 is coupled with VCC_12V end, second end of diode D5, pin 1 of relay K2, pin 2 of relay K3, pin 1 of relay K4. The pin 2 of relay K1 couple the pin 2 of relay K4, the pin 10 of high voltage, high current composite transistor array U3. The pins 6, 7, and 8 of relay K1 are coupled with the pins 6, 7, 8 and OUT+ end of relay K3. The pin 2 of relay K2 is coupled with the pin 1 of relay K3 and the pin 12 of high-withstand, high-current composite transistor array U3, and the pins 6, 7 and 8 of relay K2 are coupled with the pins 6, 7, 8 and OUT− ends of relay K4. The pins 3, 4 and 5 of relay K3 are coupled with the pins 3, 4, 5 and IN− end of relay K4.

Isolated Power Output Circuit 2 Specifications

Power range: +7 Vdc-+30 VDC

Carrying current: 80 A (continuous), 300A (3 Sec.), 600 A (1.5 Sec.)

Object of use: high current relay or low voltage IGBT

Insulation impedance: ∞

In this embodiment, the isolated power output circuit 2 consists of four relays relay (K1/K2/K3/K4) and a U3 triode switch IC. The relay applying in this embodiment is with the specification of the automotive industry, characterized by high current (lasting 80 A), high reliability, and silver alloy contacts. U3 is a high-voltage, high-current composite transistor array consisting of seven silicon NPN composite transistors.

Relays are the main components which are responsible for delivering power, with a total of 4 units, dividing into two groups. Each group take care of the power and polarity switching of OUT+ and OUT− ends. Relays K1 and K3 divides into a group and are responsible for the OUT+ end. Relays K2 and K4 divides into a group and are responsible for the OUT− end. The specific relationship table is shown in Table 2:

TABLE 2

| | OUT + end | OUT − end |
|---|---|---|
| Relay K1 | positive | |
| Relay K2 | | negative |
| Relay K3 | positive | |

The principle is as following:

When the 1PIN (EN_A) of the micro control unit 6 is a HIGH potential, the current limiting resistor R2 is coupled to U3 PIN7 (IN7) and U3 PIN7 (IN7) is a HIGH potential, U3 PIN 10 (OUT7) will be grounded to 0 potential, and at this time, the suction coil action of relay K1 and relay K4 will be pulled, and the relay suction will cause the switch to short-circuit. After the short circuit, relay K1 will send the positive voltage power, and relay K4 will send the negative voltage power. At this time, IN+ and OUT+ short circuits are coupled with each other, and IN− and OUT− short circuits are coupled with each other. At this time, the emergency power supply and car batteries are successfully bridged. In addition, the 1PIN (EN_A) of the micro control unit 6 has another path to connect to U3 PIN6 (IN6). When U3 PIN 6 (IN6) is a HIGH potential, U3 PIN 11 (OUT6) will be grounded to 0 potential, U3 PIN 11 (OUT6) will be connected to U3 PIN 5 (IN5), and U3 PIN5 (IN5) is the input control foot of EN_B (2PIN). Therefore, the input control foot of EN_B (2PIN) will also be grounded to 0 potential. The purpose of this approach is that EN_A cannot operate without EN_B so as to avoid line failure or external interference, which will cause EN_A and EN_B to start simultaneously and provide absolute safety protection for the output.

Case 2: When the 2PIN (EN_B) of the micro control unit 6 is HIGH potential, the current limiting resistor R3 is connected to U3 PIN5 (IN5) and U3 PIN5 (IN5) is HIGH potential, U3 PIN 12 (OUTS) will be grounded to 0 potential. At this time, the suction coil action of relay K2 and relay K3 will be pulled, and the relay suction will cause the switch to short-circuit. After the short circuit, the relay K2 will send the positive voltage power, and the relay K3 will send the negative voltage power. At this point, IN+ and OUT short-circuit are connected, and IN− and OUT+ short-circuit are connected. At this time, the emergency power supply and vehicle batteries are successfully bridged.

In addition, the 2PIN (EN_B) of the micro control unit 6 has another path to connect to U3 PIN4 (IN4), when U3 PIN 4 (IN4) is a HIGH potential, U3 PIN 12 (OUT6) will be grounded to 0 potential, U3 PIN 13 (OUT4) will be connected to U3 PIN 7 (IN7), and U3 PIN7 (IN7) is the input control foot of EN_A (1PIN), so the input control foot of EN_A (1PIN) will also be grounded to 0 potential, the purpose of this approach is that when EN_B is working, EN_A cannot be in motion so as to avoid line failure or external interference, which will cause EN_A and EN_B to start simultaneously and provide absolute safety protection of the output.

Referring to FIG. 5, FIG. 5 is a schematic structural view of a human-machine interface module according to an embodiment. In this embodiment, the smart vehicle battery clip 100 further includes a human-machine interface module 8, an indicator light assembly, a buzzer, a switch circuit, the indicator light assembly including a red light circuit and a green light circuit, the red light circuit including a resistor R4 and a red light LED, the first end of the red light LED is coupled with one end of the resistor R4, the other end of the resistor R4 is coupled with the VCC_12V end, and the other end of the resistor R4 is coupled with the 14-pin of the high-voltage, high-current composite transistor array U3.The green light circuit includes a resistor R5 and a green light LED, the first end of the green light LED is coupled with one end of the resistor R5, the other end of the resistor R5 is coupled with the VCC_12V end, and the other end of the resistor R5 is coupled with the 15 pins of the high-voltage, high-current composite transistor array U3. The first end of the buzzer is coupled with the VCC_12V end and the other end is coupled with the 16 pins of the high-voltage, high-current composite transistor array U3. The switching circuit includes a resistor R15, a tap switch K5, one end of the resistor R15 is coupled with to the VCC end, the other end is coupled with to the 2 pins of the tap switch K5, and the 1 pin of the tap switch K5 is coupled with to the ground GND end with 3 and 4 pins.

In order to master the real-time situation of the product for users, the human-machine interface of the product is designed to inform users about the timely situation of the product, making it easy for users to use the product and improving the perception of the product experience. The human-machine interface consists of three parts: LED tri-color indicator, buzzer, and tap switch.

The following procedure describes the human-machine interface: it consists of a co-anodic two-color LED light (red and green) and a function (reset) button, as well as a buzzer. Light numbers are two-color LED (red and green) lights that make up three colors: red, green, and orange. Flashing orange light, represents entering the voltage detection phase after normal startup 1.5 seconds red light 1 long 1 short flash (continuous) buzzer 1 long 1 short beep (continuous) represents voltage overshoot alarm. (Too high/too low) Green flashing indicates normal startup, normal battery voltage at the supply side, and can continue normal operation.

The indication of that green light is constantly lighting and the buzzer two short sounds indicates that the battery clip 1 has been clipped to the battery on the demand side, and the product has correctly identified the polarity, sending power from the supply side for ready use. A constant red light and a constant buzzer indicate overcurrent protection starts. Short red lights and short buzzers (continuous) indicate more than 5 consecutive fires. Red light 1 long 2 short flash buzzer 1 long 2 short (continuous) means temperature protection starts.

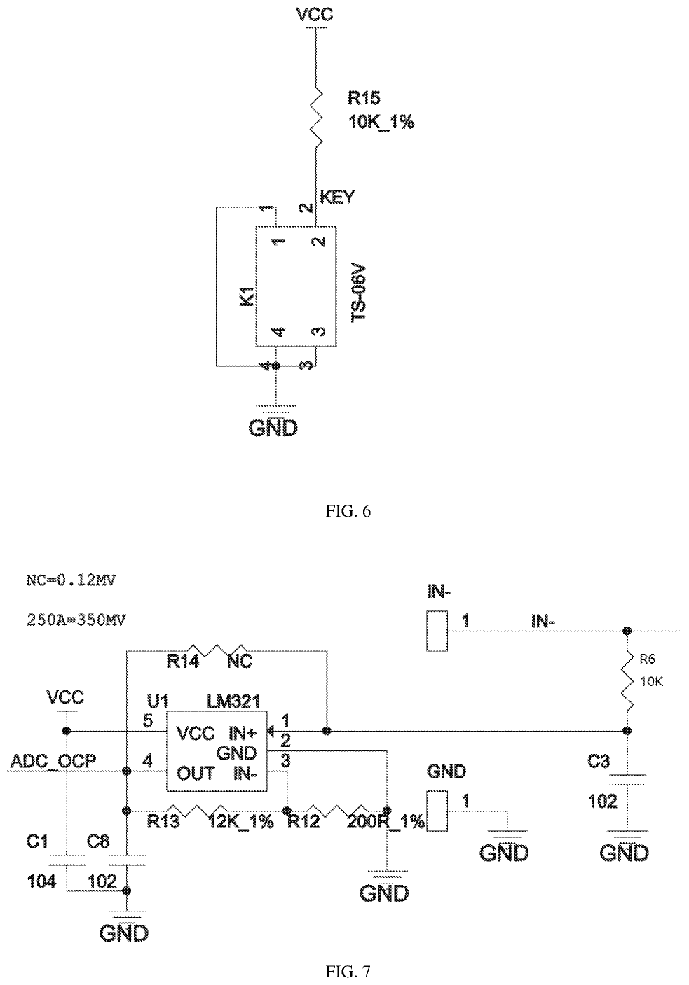

Referring to FIG. 6, FIG. 6 is a structural view of a function key switch according to an embodiment. A short press of the function key switch starts when the product is reset to the original state of startup. Long press for 10 seconds to convert automatic detection to manual +/−polarity to prevent any faults such as battery short circuit, ultra-low voltage (below 2.3 Vdc), battery severe power failure, and no battery. The product embodies this embodiment can also be running at this situation. When entering the manual judgment mode, there is a limited time limit of 60 seconds, and the car needs to be started within 60 seconds. Otherwise, the automatic exit mode can be restored to the automatic detection mode, and the manual mode can be started again by pressing the long button. In the manual judgment mode, the positive and negative polarity is fixed, which can be determined according to the wire color. The red line is the positive pole, the black line is the negative pole, and the corresponding battery positive and negative poles. The principle is as following:

The U3 IC PIN2 (IN2) is connected to the IC1 MCU PIN5 (LED_G). When this pin outputs the HIGH potential, the U3 IC PIN15 (OUT2) pin is grounded (0 potential). At this time, the green light is lighting, and the resistor R5 plays the role of current limiting. The U3 IC PIN3 (IN3) is connected to the IC1 MCU PIN3 (LED_R). When this pin outputs a HIGH potential, the U3 IC PIN14 (OUT3) pin is grounded (0 potential). At this time, the red light is lighted and the resistor R4 plays the role of current limiting.

When the U3 IC PIN2 (IN2) and U3 IC PIN3 (IN3) are connected to the HIGH potential simultaneously, the U3 IC PIN15 (OUT2) and U3 IC PIN14 (OUT3) are grounded simultaneously (0 potential), and the red, green lights are illuminated simultaneously, and the orange effect lights are displayed when both lights are illuminated simultaneously.

The U3 IC PIN1 (IN1) is connected to the IC1 MCU PIN6 (BUZ_EN) pin, and when this pin outputs a HIGH potential, the U3 IC PIN16 (OUT1) is grounded (0 potential), at this time, the buzzer (BUZ1) is activated and sounds. K5 is a tap switch that grounds the HIGH potential on the resistor R15 and generates a signal to press the switch, which is sent to the IC1 MCU PIN14 (KEY) to enable the IC1 MCU to recognize that the function key has been triggered. The HMI logic table is as shown in table 3.

TABLE 3

| | IC1 MCU | IC1 | IC1 MCU | IC1 MCU |
|---|---|---|---|---|
| | PIN5 | MCU PIN3 | PIN6 | PIN 14 |
| Red light turned on | 0 | 0 | 0 | 0 |
| Red light turned on | 0 | 1 | 0 | 0 |
| Green light turned off | 0 | 0 | 0 | 0 |
| Green light turned on | 1 | 0 | 0 | 0 |
| Orange light turned | 1 | 1 | 0 | 0 |
| on | | | | |
| Buzzer | 0 | 0 | 1 | 0 |
| Switch triggered | 0 | 0 | 0 | 1 |

In this embodiment, the micro control unit (MCU) is the central processor of the product, the brain of the product, judging and controlling the product with various implanted program logic. Micro Control Unit 66 (MCU) product, model PMS171B-S14, 8-bit OTP MCU with 8-bit ADC 11 channels. The MCU footprint description is shown in Table 4.

TABLE 4

| Pin | Function | Pin | Function |
|---|---|---|---|
| 1 EN_A Control power | Control power output | 14 KEY | Control tact switch circuit |
| output | circuit A | | |
| 2 EN_B | Control power output | 13 ADC_OCP | Control overcurrent |
| | circuit B | | protection circuit 5 |
| 3 LED_R | Control LED red light | 12 IN_A | Control polarity |
| | circuit | | discrimination circuit 4A |
| 4 VCC | Power pin + 5Vdc | 11 GND | Power pin grounded (0 |
| | | | potential) |
| 5 LED_G | Control LED green light | 10 IN_B | Control polarity |
| | circuit | | discrimination circuit 4B |
| 6 BUZ_EN | Control buzzer circuit | 9 ADC_OTP | Control temperature |
| | | | protection circuit 5 |
| 7 REST | N/A | 8 ADC_BAT | Control high and low |
| | | | voltage protection circuit 5 |

In an embodiment, the protection circuit 5 includes an overcurrent protection circuit, a high and low voltage protection circuit, a short circuit protection circuit, and a temperature protection circuit.

Referring to FIG. 7, FIG. 7 is a schematic structural view of an overcurrent protection circuit according to an embodiment. In this embodiment, the overcurrent protection circuit includes a resistor R6, a resistor R12, a resistor R13, a resistor R14, an op-amp U1, a capacitor C1, a capacitor C3, a capacitor C8, one end of a resistor R6 is coupled with an IN− end, the other end of a resistor R14, one end of a capacitor C3, a pin of an op-amp U1, the other end of a capacitor C3 is coupled with a ground GND end. The other end of the resistor R14 is coupled with the pin 4 of the operational amplifier U1, one end of the capacitance C8, one end of the resistor R13, the other end of the resistor R13 is coupled with the one end of the resistor R12, the pin 3 of the operational amplifier U1, the other end of the resistor R12 is coupled with the pin 2 of the operational amplifier U1, the ground GND end. One end of capacitor C1 is coupled with the pin 5 of op-amp U1, the VCC end, and the other end is coupled with the other end of capacitor C8.

The instantaneous current of this product is quite large and the set protection point is 600 A. The current detection assembly adopts a 10 AWG line segment (length 20 mm), the pin 1 of the resistor R6 to the op-amp U1 can be referred to as the R line segment, which spans IN− and GND for the purpose of capturing the voltage values at both ends of the line segment when passing the current.

Let's start with this wire specification: 10 AWG (1050*0.018) TS outer diameter 5.45±0.15 mm, insulating material silicone conductor cross-sectional area 26.72 mm2, conductor resistor Max 3.55 Ω/km. Using its resistor to calculate our 20 mm length line segment impedance is 0.07 mΩ.

The U1 IC is an operational amplifier (OP AMP.), the main purpose is to be the current detection amplifier, that is, amplify the voltage value on the R line segment to detect the current more sharply and quickly. Resistor R6 connects to U1 OP AMP after taking the voltage value on the R line segment from IN− End. On pin 1 (in+in-phase input), u1 op amp. Resistor R13 to U1 OP AMP is connected to the PIN4 (OUT output). On pin3 (in inverse input), u1 op amp. Another resistor R12 resistor (0 potential) is connected to the PIN3 (IN− inverse input), this type of design is called a Voltage/current conversion circuit, and with the feedback circuit of resistor R13, resistor R12 (dead cycle mode), U1 OP AMP. The input voltage of PIN1 (IN+in-phase input) amplifies the output and is then amplified by U1 OP AMP. The PIN4 (OUT output) sends the amplified voltage to the PIN 13 ADC_OCP of the micro control unit (MCU) for the analysis of the current protection work.

The operation is as following:

Vo=IiR(R1+R2)/R2=600 RIi

Nc=0.12 mV

1 A=1.4 mV

300 A=420 mV

600 A=840 mV

The micro control unit (MCU) programs the numerical values of the protection timing according to the above calculated values.

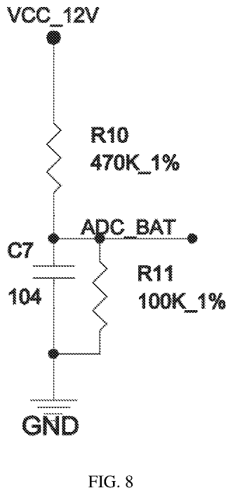

Referring to FIG. 8, FIG. 8 is a structural view of a high and low voltage protection circuit according to an embodiment. In this embodiment, the high and low voltage protection circuit includes a resistor R10, a resistor R11, a capacitor C7, one end of the resistor R10 is coupled with a VCC_12V end, the other end of the capacitor C7 is coupled with one end of the capacitor C7, the other end of the capacitor C7 is coupled with a ground GND end, the resistor R11 being in parallel with the capacitor C7.

After startup, the product will automatically perform the function of battery voltage detection. After the detection is passed, it can enter the standby mode. If there is any abnormality, it can enter the alarm mode (refer to the introduction of the human-machine interface), and lock the product restriction operation. The so-called abnormality refers to: less than the range of voltage ≤12 Vdc and more than voltage ≥17.5 Vdc.

The purpose of low voltage protection is to prevent excessive discharge of the battery. The purpose of high voltage protection is to prevent the battery from being discharged by a large current immediately after overcharging, so as not to cause battery safety problems. Whenever a voltage abnormality occurs, the product is locked and restricted to use.

The principle is as following:

the resistor R10 and the resistor R1 are connected in series to form a voltage divider circuit. After the resistor R10 takes the voltage from the VCC_12V end, it divides the voltage through the resistor R11 and takes a stable distribution voltage value. The capacitance C7 MLCC is a stabilizing effect on energy storage. This assigned voltage value is sent to the PIN 8 ADC_BAT foot of the IC1 micro control unit, and the voltage level is determined by the program within the micro control unit (MCU).

Operating formula:

Low voltage setting

ADC_BAT=(R11/(R10+r11))*VCC_12v=100K/570K*12V=2.105V

High Voltage setting

ADC_BAT=(R11/(R10+R11))*VCC_12v=100K/570kK*17.5V=3.07V

Once these two values are written into the program, the IC1 micro control unit (MCU) can recognize the high and low voltage values.

In an embodiment, the circuitry in the present disclosure also provides short-circuit protection. This product also plans the output short-circuit function, it does not operate as a separate line, it utilizes the product's isolated insulated output characteristics and over-current protection functions to combine the protection functions. The principle is as following:

When there is a voltage input and the voltage is higher than 2.3V, the polarity detection circuit will operate, but when the output short circuit, the voltage must be lower than 2.3V, at which point the polarity detection circuit will be unrecognizable, at which point the relay will all jump back to OPEN, the output power will be interrupted, and the protection work will be completed. On the other hand, the instantaneous current of the short-circuit is large. When the current exceeds the current protection point during the short circuit, the over-current protection function will also be triggered to protect the locking machine.

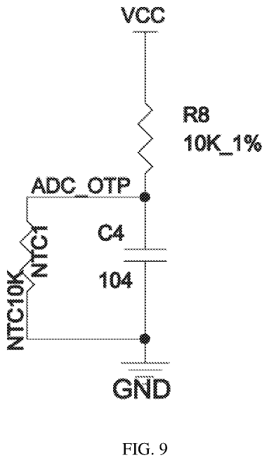

Referring to FIG. 9, FIG. 9 is a structural view of a temperature protection circuit according to an embodiment. In this embodiment, the temperature protection circuit includes NTC thermistor, resistor R8, capacitor C4, one end of resistor R8 is coupled with VCC end, the other end of capacitor C4 is coupled with ground GND end, NTC thermistor is in parallel with capacitor C4.

The production embodied the present disclosure is designed with over-temperature protection function. At the same time as using the product, the internal temperature of the product is monitored at any time. If the internal temperature is over-temperature, the product will be locked as well. It is prohibited to use the product, and the human-machine interface starts alarm (refer to the introduction of the human-machine interface). The value falls below 45° C., the protective state is released, the human-machine interface alarm is stopped, and the product function is restored. The product operates under high current conditions. If the user uses the product excessively or for too long, the product will quickly accumulate internal temperature, so it is important to do temperature protection, not only to extend the life of the product, but also to protect the user's safety without causing any harm caused by the high temperature. This protection circuit 5 is mainly practiced with the use of NTC (Negative Temperature Coefficient) components. The principle is as following:

NTC thermistor is a thermo resistive device of semiconductor ceramics that utilizes a negative temperature coefficient (NTC) relationship between resistor and temperature, and has a very high rate of change. Utilizing this property, it is used not only as a temperature sensor, but also as a temperature protection device like temperature detection and temperature compensation.

NTC thermistor is a thermistor device whose resistor value drops sharply as the temperature rises. With this property, in addition to the temperature sensor, it can also be used as a temperature protection device to protect the circuit 5 from the effects of overheating.

The resistors R8 and NTC1 (NTC thermistor) are connected in series to form a voltage divider circuit. After the resistor R8 takes the voltage from the VCC end, it divides the voltage through NTC1 and takes a stable distribution voltage value. The capacitance C4 MLCC is a stabilizing effect on energy storage. This assigned voltage value is sent to the PIN 9 ADC_OTP foot of the IC1 micro control unit, and the temperature is determined by the program within the micro control unit (MCU).

Operating formula:

Ambient temperature setting (25° C.)

ADC_OTC=(NTC1/(R8+NTC1))*VCC=10K/20K*5V=2.50V

Restore temperature setting (45° C.)

ADC_OTC=(NTC1/(R8+NTC1))*VCC=4.92K/14.92K*5V=1.65V

Protection temperature setting (80° C.)

ADC_OTC=(NTC1/(R8+NTC1))*VCC=1.67K/11.67K*5V=0.7155V

By writing these three values into the program, the IC1 micro control unit (MCU) can identify the range of high and low temperatures.

When the user actually operates, insert the EC5 male plug of the product into the EC5 female socket of the emergency power supply. After the product is powered from the EC5 female socket of the emergency power supply, it will automatically start up, and immediately enter the voltage detection program. The human-machine interface flashes orange light. After 1.5 seconds, it will automatically enter the standby state after normal, and the human-machine interface flashes green light. At this time, the product enters the standby state. At any time during the standby state, there is a voltage input at the detection end of the battery clip 1. If the voltage input is not determined, the cycle detection continues. The human-machine interface continues to flash green.

There is a voltage input on the battery clip 1. After the detection circuit of the battery clip 1 determines the polarity and sends it to the micro control unit 6 for polarity confirmation, the output power circuit control is carried out. At this time, the positive and negative polarity sent by the power control circuit and the polarity of the detection end judge the input are consistent. At this time, the positive and negative polarity of the power supply ends, and the demand end have been correctly connected, and the human-machine interface turns on normally. The buzzer sounds two short prompts. At this time, the equipment has done all the work of emergency startup and bridge-building, and is at any time supplying electricity to the car startup motor. At this time, as long as the car key is twisted to the start lighting position, electricity can be delivered to the car startup motor, and then the car engine can be started to complete the lighting program. After the car engine is started, please remember to unplug the battery clip, let the product completely disconnect from the car battery, and press the function reset key or unplug the product plug from the emergency power outlet before the next use to reset the system for the next use.

In order for the product to be plugged into the emergency power supply for a long time, without consuming too much battery power, it is specially designed to go to sleep after no operation for 10 minutes. After entering the sleep state, you can wake up by using the following methods: 1. Take the EC5 socket out from the emergency power supply and reinsert the activation function. 2. Press the function reset key to activate the function.

In the protection circuit 5 of the present embodiment, the overcurrent protection condition is more than 300 A (3 Sec.), 600 A (1.5 Sec.), the power output circuit fails to lock in all states, and the human-machine interface starts the alarm prompt. Object used: 10 AWG copper wire 20 mm line segment or high-current copper wire or high-current detection of insensitive alloy resistor.

Low voltage protection: When the product starts up, the voltage of the lithium battery (equivalent or other battery specification) at the emergency power supply end is detected. The detection time is 1.5 seconds. When the voltage is below +12 Vdc, the power output circuit is locked and the alarm prompt of the human-machine interface is activated. When the voltage is normal, it enters the boot standby state.

High voltage protection: When the product starts up, the voltage of the lithium battery (equivalent or other battery specification) at the emergency power supply end is detected. The detection time is 1.5 seconds. When the voltage is higher than +17.5 Vdc, the power output circuit is locked and the alarm prompt of the human-machine interface is activated. When the voltage is normal, it enters the boot standby state.

Short-circuit protection: During the product stage, when the positive and negative poles are short-circuited inadvertently, the short-circuit protection will be activated, and the protection mechanism will be activated when the voltage drops to ≤1 Vdc within 1 mS. After entering the protected state, the motherboard is restarted (losing power) and all states are reset to the boot state.

Temperature protection: the temperature setting point is 80° C., when using the product; if the internal temperature of the product exceeds 80° C., the temperature protection function will be activated, the power output circuit will be disconnected after startup, and the product will be locked for non-use, and the alarm prompt of the human-machine interface will be activated. Until the temperature in the machine drops back to 45° C. to unlock and alarm.

The technical solutions presented in this application also have the following advantages:

In order to adapt to the various phenomena of automobile battery failure, the design manually intervenes in the judgment function, but this function needs to be completed within a limited time, after which the intelligent judgment mode will be automatically restored to ensure the experience of intelligent products is uninterrupted. A thoughtful human-machine interface. After inserting the product, the smart program will automatically detect the various conditions for the car to start lighting, timely message response to users by giving the sound and light, and the user can easily grasp the situation. Ultra-low battery voltage detection capability. As long as there is a voltage of >2.3 Vdc on the car battery, the product can detect and recognize polarity, expand the detection capability of faulty batteries, and apply to a wider area. Save electric sticker design. After 10 minutes of product standby, when there is no operation, the product will automatically go into a dormant state. Avoid excessive waste of power on emergency power supplies. Allow the user to plug into the emergency power supply for a long time without worrying about power consumption. Sleep consumes only 20 μA of electricity.

The present disclosure provides a smart vehicle battery clip 100 comprising: two battery clips 1, an isolated power output circuit 2, an isolated polarity detection circuit 3, a polarity discrimination circuit 4, a protection circuit 5, a micro control unit 66, and a power supply circuit 7, the isolated power output circuit 2 is coupled with two battery clips 1, the isolated polarity detection circuit 3 and the isolated power output circuit 2 are spaced apart, and the two battery clips 1 are coupled; the polarity discrimination circuit 4 and the isolated polarity detection circuit 3 are relatively arranged, and the polarity discrimination circuit 4 and the isolated polarity detection circuit 3 are isolated; the micro control unit 66 is coupled with the isolated power output circuit 2, the polarity discrimination circuit 4, the EC5 male socket, and the protection circuit 5; and the power supply circuit 7 and the micro control unit are spaced apart. By setting the isolation power output circuit 2 and the isolation polarity detection circuit 3, the unique isolation design has high insulation characteristics at both ends to avoid electric leakage, electric shock, static electricity, etc. The isolated polarity detection circuit 3 has the function of polarity identification and transmitting an identifiable signal to the polarity discrimination circuit 4, so as to improve the personal safety of the user.

The foregoing is merely an implementation of the present disclosure and is not intended to limit the patent scope of the present disclosure. Any equivalent structure or equivalent process transformation made with the contents of the application specification and the accompanying drawings, or directly or indirectly applied in other related technical fields, are equally included in the patent protection scope of the present disclosure.

What is claimed is:

1. A smart vehicle battery clip, comprising:
two battery clips; an isolated power output circuit; an isolated polarity detection circuit; a polarity discrimination circuit; a protection circuit; a micro control unit; and a power supply circuit, wherein the isolated power output circuit is couples with the two battery clips, the isolated polarity detection circuit is spaced apart from the isolated power output circuit, and coupled with the two battery clips; the polarity discrimination circuit is arranged on the opposite side of the isolated polarity detection circuit, and the polarity discrimination circuit is isolated from the isolated polarity detection circuit; the micro control unit is coupled with the isolated power output circuit, the polarity discrimination circuit, an EC5 male socket, and the protection circuit; the power supply circuit is spaced apart from the micro control unit.

2. The smart vehicle battery clip according to claim 1, wherein the power supply circuit further comprises a first supply circuit and a second supply circuit, the first supply circuit includes a diode D5, one end of the diode D5 is coupled to an IN+ end of the EC5 male socket, and the other end of the diode D5 is coupled to a VCC_12V end of the second supply circuit; the second supply circuit includes a R9 resistor, a capacitor C5, a DC voltage stabilizer U13, and a capacitor C6, one end of the R9 resistor is coupled with the VCC_12V end, the other end of the R9 resistor is coupled with one end of the capacitor C5 and an IN pin of the DC voltage stabilizer U13, the other end of the capacitor C5 is coupled with one end of the capacitor C6, one end of the capacitor C6 is coupled to an OUT pin and a VCC end of the DC voltage stabilizer U13; and two GND pins of the DC voltage stabilizer U13 are coupled with the other end of the capacitor C5 and a ground GND end of the capacitor C5.

3. The smart vehicle battery clip according to claim 1, wherein the smart vehicle battery clip further comprises a first optical coupling assembly U37 and a second optical coupling assembly U38, the first optical coupling assembly U37 includes a first optical diode and a first optical triode, the second optical coupling assembly U38 includes a second optical diode and a second optical triode; the isolation polarity detection circuit includes a resistor R7, the two ends of the resistor R7 are respectively coupled with a first end and an OUT+ end of the first optical diode, the second end of the first optical diode is coupled with a second end of the second optical diode, and the first end of the second optical diode is coupled with an OUT− end.

4. The smart vehicle battery clip according to claim 3, wherein the polarity discrimination circuit further comprises a resistor R16 and a resistor R1, a collector pin of the first light triode is coupled with one end of the resistor R16, the other end of the resistor R16 is coupled with one end of the resistor R1 and a VCC end; an emitter pin of the first light triode is coupled with an emitter pin of the second light triode and a ground GND end, and a collector pin of the second light triode is coupled with the other end of the resistor R1.

5. The smart vehicle battery clip according to claim 1, wherein the isolated power output circuit comprises a relay K1, a relay K2, a relay K3, a relay K4, a high-voltage and high-current composite transistor array U3, a diode D5, and a resistor R6, pins 3, 4, and 5 of the relay K1 are coupled with a first end of the diode D5, a IN+ end, pins 4 and 3 of the relay K2; a pin 1 of the relay K1 is coupled with the a VCC_12V end, a second end of the diode D5, a pin 1 of the relay K2, a pin 2 of the relay K3, a pin 1 of the relay K4, a pin 2 of the relay K1, and a pin 2 of the relay K4; a pin 10 of the high-voltage and high-current composite transistor array U3 is coupled with a pin 2 of the relay K1; pins 6, 7, and 8 of the relay K1 are coupled with pins 6, 7, and 8 of the relay K3 and an OUT+ end; a pin 2 of the relay K2 is coupled with a first pin of the relay K3, a pin 12 of the high-voltage and high-current composite transistor array U3; The pin 6, 7 and 8 of the relay K2 are coupled with the pins 6, 7 and 8 of the relay K4 and an OUT− end; pins 3, 4 and 5 of the relay K3 are coupled with pins 3, 4 and 5 of the relay K4 and an IN− end.

6. The smart vehicle battery clip according to claim 5, wherein the smart vehicle battery clip further comprises a human-machine interface module, which includes an indicator light assembly, a buzzer, and a switch circuit, the indicator light assembly includes a red light circuit and a green light circuit, the red light circuit including a resistor R4 and a red light LED, a first end of the red light LED is coupled with one end of the resistor R4, the other end is coupled with the VCC_12V end, the other end of the resistor R4 is coupled with a pin 14 of the high voltage and high-current composite transistor array U3; the green light circuit includes a resistor R5 and a green light LED, a first end of the green light LED is coupled one end of the resistor R5 and the other end of the resistor R5 is coupled with a pin 15 of the high-voltage and high-current composite transistor array U3; a first end of the buzzer is coupled with the VCC_12V end and the other end is coupled with a pin 16 of the high-voltage and high-current composite transistor array U3; the switching circuit includes a resistor R15, a tap switch K5, one end of the resistor R15 is coupled to a VCC end, the other end is coupled to a pin 2 of the tap switch K5, and pins 1, 3 and 4 of the tap switch K5 is coupled with the ground GND.

7. The smart vehicle battery clip according to claim 1, wherein the protection circuit comprises an overcurrent protection circuit, a high and low voltage protection circuit, a short circuit protection circuit, and a temperature protection circuit.

8. The smart vehicle battery clip according to claim 7, wherein the overcurrent protection circuit comprises a resistor R6, a resistor R12, a resistor R13, a resistor R14, an operational amplifier U1, a capacitance C1, a capacitance C3, a capacitance C8, one end of the resistor R6 is coupled with an IN− end, the other end is coupled with one end of the resistor R14, one end of the capacitance C3, a pin 1 of the operational amplifier U1; the other end of the capacitance C3 is coupled with a ground GND end; the other end of the resistor R14 is coupled with a pin 4 of the operational amplifier U1, one end of the capacitance C8 and one end of the resistor R13; The other end of the resistor R13 is coupled to one end of the resistor R12 and a pin 3 of the operational amplifier U1, and the other end of the resistor R12 is coupled to the pin 2 of the operational amplifier U1 and the ground GND end; one end of the capacitor C1 is coupled to a pin 5 and a VCC end of the operational amplifier U1, and the other end is coupled to the other end of the capacitor C8.

9. The smart vehicle battery clip according to claim 7, wherein the high and low voltage protection circuit comprises a resistor R10, a resistor R11, a capacitance C7, one end of the resistor R10 is coupled with a VCC_12V end, the other end is coupled with one end of the capacitance C7, the other end of the capacitance C7 is coupled with a ground GND end, and the resistor R11 is connected in parallel with the capacitance C7.

10. The smart vehicle battery clip according to claim 7, wherein the temperature protection circuit comprises an NTC thermistor, a resistor R8, a capacitor C4, one end of the resistor R8 is coupled with a VCC end, the other end of the capacitor C4 is coupled with a ground GND end, and the NTC thermistor is connected in parallel with the capacitor C4.
